(19) United States
(12) Patent Application Publication
(10) Pub. No.: US 2012/0276789 A1
(43) Pub. Date: Nov. 1, 2012

(54) POWER LINE COUPLER

(75) Inventor: Robert James Battle, Yatala (AU)

(73) Assignee: SICAME AUSTRALIA PTY LTD, Yatala (AU)

(21) Appl. No.: 13/467,154

(22) Filed: May 9, 2012

Related U.S. Application Data
(63) Continuation-in-part of application No. 12/603,287, filed on Oct. 21, 2009, now Pat. No. 8,202,131.

(51) Int. Cl. H01R 11/09; H01R 43/00

(52) U.S. Cl. 439/797; 29/869

(57) ABSTRACT

The present invention relates to a power line coupler for coupling a pair of cables together. The coupler includes a protector for receiving and protecting the cables. The protector includes a pair of protection members between which the cables can be received. A clamp is provided for clamping the protector and cables together.

This application is a continuation-in-part application of pending application Ser. No. 12/603,287 filed Oct. 21, 2009 which is hereby incorporated by reference.

### TECHNICAL FIELD

The present invention generally relates to a power line coupler.

### BACKGROUND

The reference to any prior art in this specification is not, and should not be taken as an acknowledgement or any form of suggestion that the prior art forms part of the common general knowledge.

An overhead power line is an electric power transmission line suspended by towers or poles. Overhead power lines are generally the lowest-cost method of transmission for large quantities of electric power in the range 1 kV to 800 kV. In practice, many overhead power line cables are bare conductors which make them hazardous.

During storms, trees or branches can fall over power lines causing them to break. It is desirable to quickly couple the two separate cables of a broken power line back together so as to remove the hazard, rather than go to the trouble and expense of re-installing a complete power line.

A known power line coupler for coupling a pair of cables together includes a helical conductor which is tightly wound from one cable onto the other. In practice, the repaired and sagging power line can swing in the wind (e.g. during subsequent storms) and the helical conductor can slip from a cable about which it is wound.

Another power line coupler includes a compressible conductor tube for receiving the cables. Once the cables are inserted, the tube can be compressed and deformed so as to clamp the cables therein. However, in practice, the cable thicknesses are prone to variation owing to different manufacturer's specifications. Accordingly, it may be difficult to insert some thicker cables into the tube whereas the tube may be inadequately clamped to other thinner cables which can make the joint susceptible to breakage once again.

### SUMMARY OF THE INVENTION

According to one aspect of the present invention, there is provided a power line coupler for coupling a pair of cables together, the coupler including:
a protector for receiving and protecting the cables, the protector including a pair of protection members between which the cables can be received; and
a clamp for clamping the protector and cables together.

Optionally, the protection members are coated with a friction enhancing compound to impede extraction of the cables. Optionally, the protection members are formed from deformable aluminum.

Optionally, the clamp includes a plurality of inner protrusions. The protrusions may be located on one side of the coupler and fasteners may be located on the other side of the coupler. The protrusions and fasteners may be alternatingly disposed so that, in use, the protector is corrugated and resists extraction from the clamp. Each fastener may include a head from which a threaded shaft extends, the head defining a recess such that a tip of the head can be separated from the fastener by shearing. The tip may include a base shelf for impeding tool slippage when separating the tip

Optionally, the power line coupler further includes a locator extending through the protector and against which the cables inserted from opposite sides of the coupler can be located. The clamp may include a tube. The clamp may include one or more endcaps for capping the tube.

According to another aspect of the present invention, there is provided a power line coupler for coupling a pair of cables together, the coupler including:
an inner pair of protection members for receiving the cables; and
a tube for receiving the protection members.

According to another aspect of the present invention, there is provided a power line coupler for coupling a pair of cables together, the coupler including:
protector means for receiving and protecting the cables;
clamp means for clamping the protector means and cables together; and
a plurality of inner protrusions located within the clamp means to bear against the protector means.

According to another aspect of the present invention, there is provided a power line coupling method for coupling a pair of cables together, the method including the steps of:
receiving the cables within a protector; and
clamping the protector and cables together using fasteners on one side of the protector only.

The step of clamping may involve separating a tip of the fasteners by shearing.

### BRIEF DESCRIPTION OF THE DRAWINGS

Preferred features, embodiments and variations of the invention may be discerned from the following Detailed Description which provides sufficient information for those skilled in the art to perform the invention. The Detailed Description is not to be regarded as limiting the scope of the preceding Summary of the Invention in any way. The Detailed Description will make reference to a number of drawings as follows:

FIG. 1 is a perspective view of an overhead power line coupler;

FIG. 2 is a partial side sectional view of the power line coupler of FIG. 1;

FIG. 3 is an end view of the power line coupler of FIG. 1;

FIG. 4 is a side sectional view of the power line coupler of FIG. 1 coupling a pair of cables together;

FIG. 5 is a perspective view of an overhead power line coupler in accordance with an embodiment of the present invention;

FIG. 6 is a partial side sectional view of the power line coupler of FIG. 5;

FIG. 7 is an end view of the power line coupler of FIG. 5; and

FIG. 8 is a side sectional view of the power line coupler of FIG. 5 coupling a pair of cables together.

### DETAILED DESCRIPTION OF PREFERRED EMBODIMENT(S)

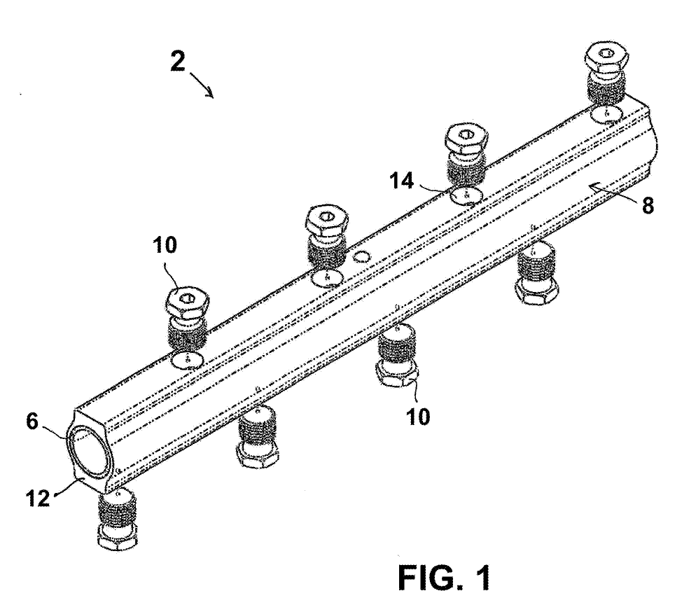

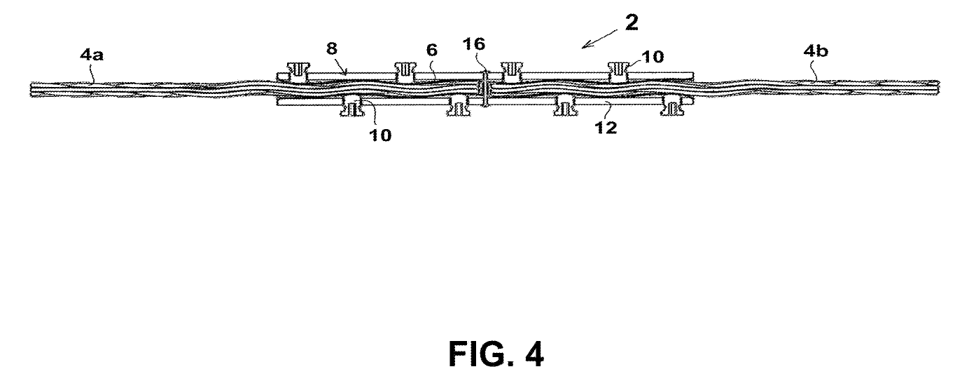

There is provided an overhead power line coupler 2 as shown in FIGS. 1 to 3. The power line coupler 2 is suitable for electrically coupling a pair of cables 4a, 4b together as shown in FIG. 4.

Turning firstly to FIG. 1, the coupler 2 includes a tubular protector 6 for receiving and protecting the cables 4 from damage by the base of clamp fasteners 10. A tubular clamp 8 can be used to clamp the protector 6 and cables 4 together so that the cables 4 are coupled together and resist slipping from the protector 6.

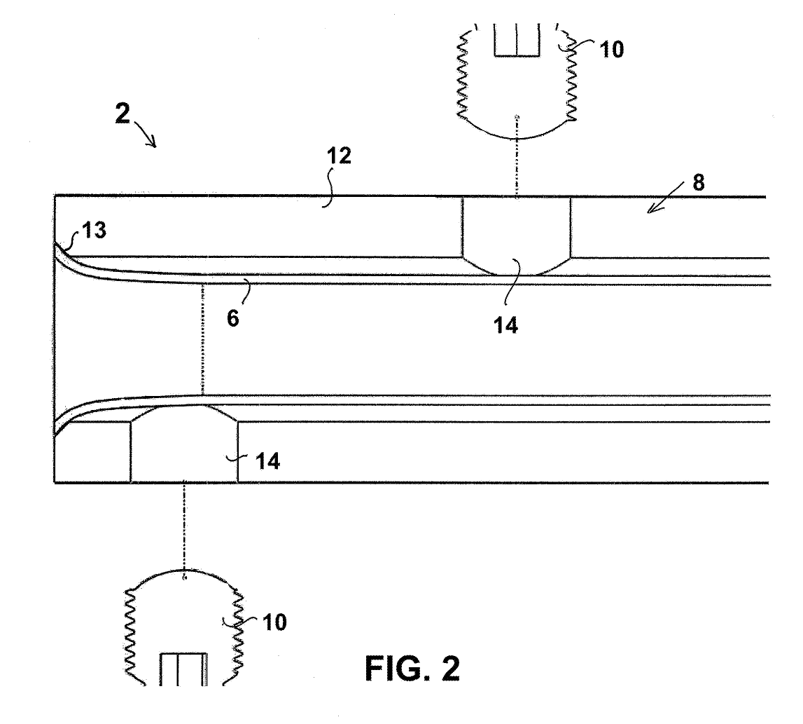

The protector 6 is in the form of an inner tube in which the cables 4a, 4b can be inserted from opposite sides (FIG. 4). To facilitate insertion of the cables 4, the protector 6 includes an inner lubricant in the form of grease. As can best be seen in FIG. 2, the protector 6 widens at both ends so as to be retained within the clamp 8. The protector 6 is formed from deformable aluminum and becomes corrugated (or undulates) when clamped so as to further resist extraction from the clamp 8.

The clamp 8 includes an outer tube 12 in which the protector 6 is located. The outer tube 12 includes threaded holes 14 in which respective fasteners 10 can be engaged. The clamp 8 includes the fasteners which each take the form of a bolt. The outer tube 12 is formed from comparatively durable aluminum and has chamfered or beveled inner edges 13 which engage with the widened ends of the protector 6.

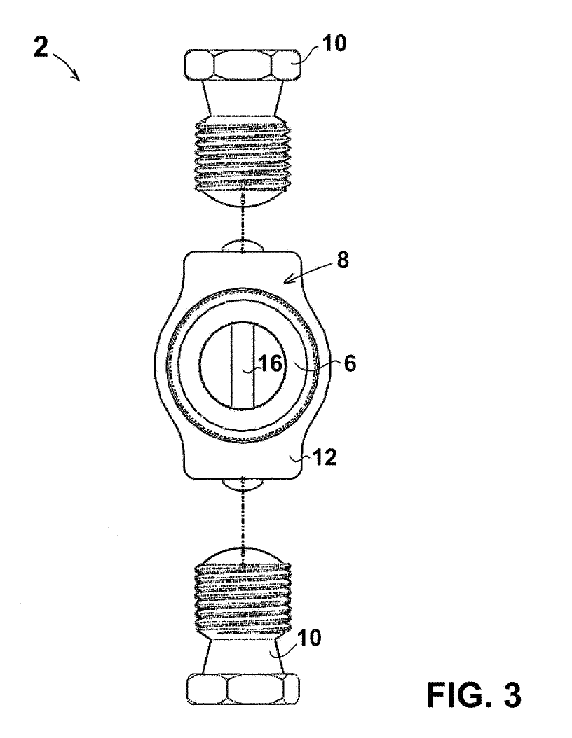

As can best be seen in FIG. 3, the coupler 2 further includes a pin 16 extending through the protector 6 and clamp 8. The pin 16 holds the protector 6 within the clamp 8 and further provides a stop against which the cables 4 can be positioned when fully inserted in the coupler 2.

The method for coupling a pair of cables 4a, 4b of a broken power line together with the coupler 2 is described in detail below.

Initially, the cables 4a, 4b are inserted within opposite ends of the protector 6.

The clamp 8 is clamped onto the protector 6 so that the protector 6 and cables 4a, 4b are clamped together. Elaborating further, the fasteners 10 are tightened which, in turn, deforms the protector 6. As previously explained, the protector 6 protects the strands of each cable 4 from damage during tightening of the fasteners 10.

The cables 4 can be firmly held within the protector 6, irrespective of their diameter. Each of the aluminum protector 6, clamp 8 and fasteners 10 are electrically conductive so that the cables 4a, 4b are electrically coupled together.

Typically, the cables 4a, 4b are bare (i.e. not insulated). In one embodiment, insulation can instead be stripped from the ends of the cables 4a, 4b prior to coupling them together.

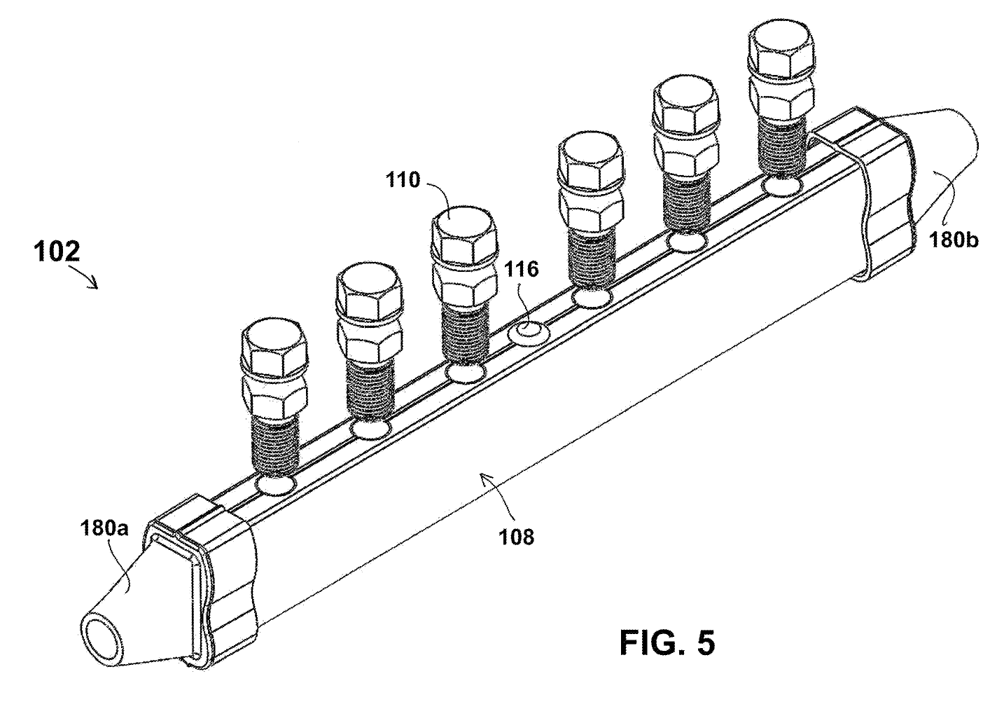

According to an embodiment of the present invention, there is provided an overhead power line coupler 102 shown in FIGS. 5 to 7 for coupling a pair of cables 104a, 104b together.

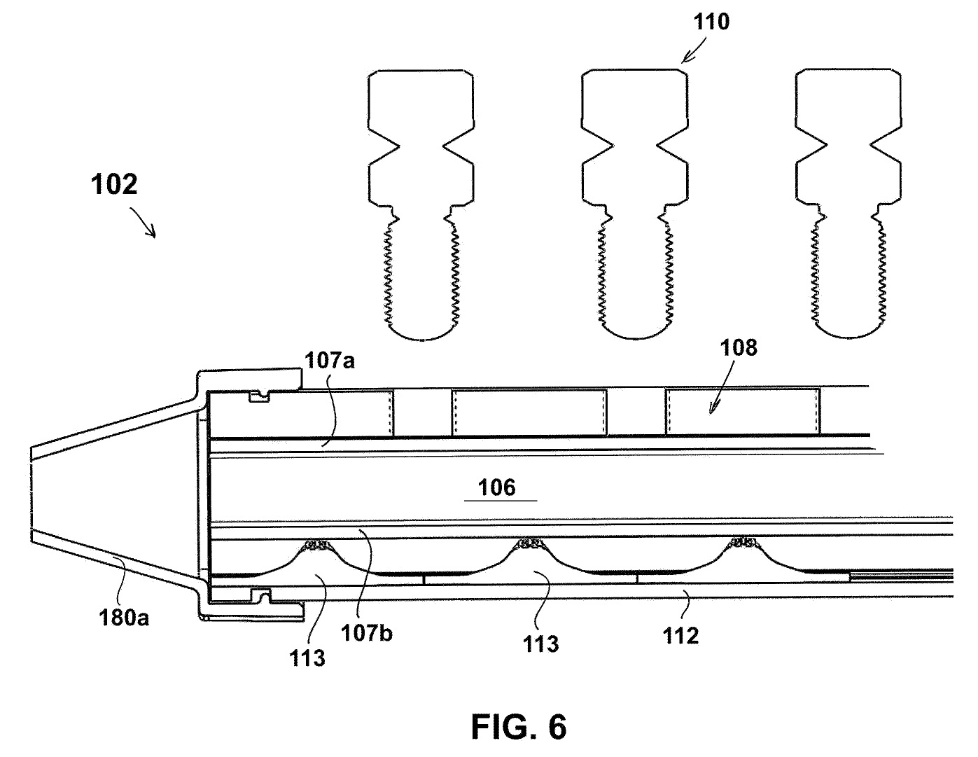

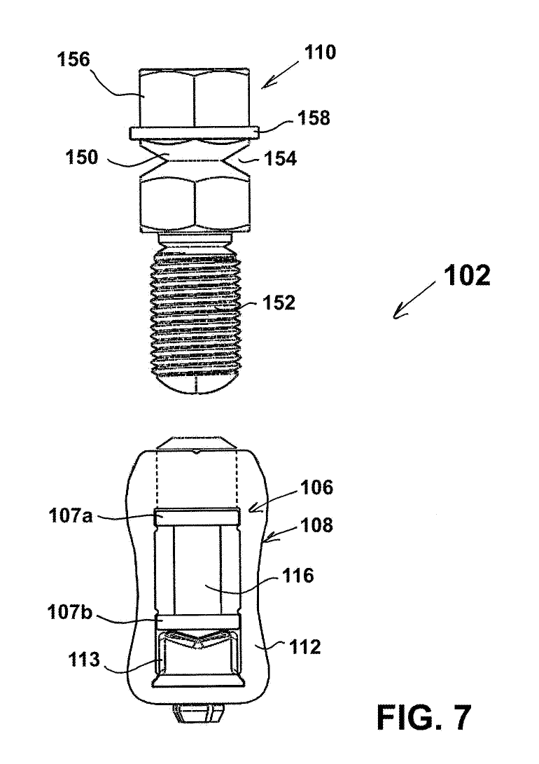

As can best be seen in FIGS. 6 and 7, the coupler 102 includes an inner protector 106 for receiving and protecting the cables 104. The protector 106 includes a pair of protection members 107a, 107b, in the form of aluminum plates, between which the cables 104 can be received. The coupler 102 further includes an outer clamp 108 for clamping the protector 106 and cables 104 together.

The protection members 107a, 107b are coated on their inwardly faces with a friction enhancing compound (e.g. carborundum) to impede extraction of the cables 104. Advantageously, the friction enhancing compound reduces the clamping torque required to hold the cables 104.

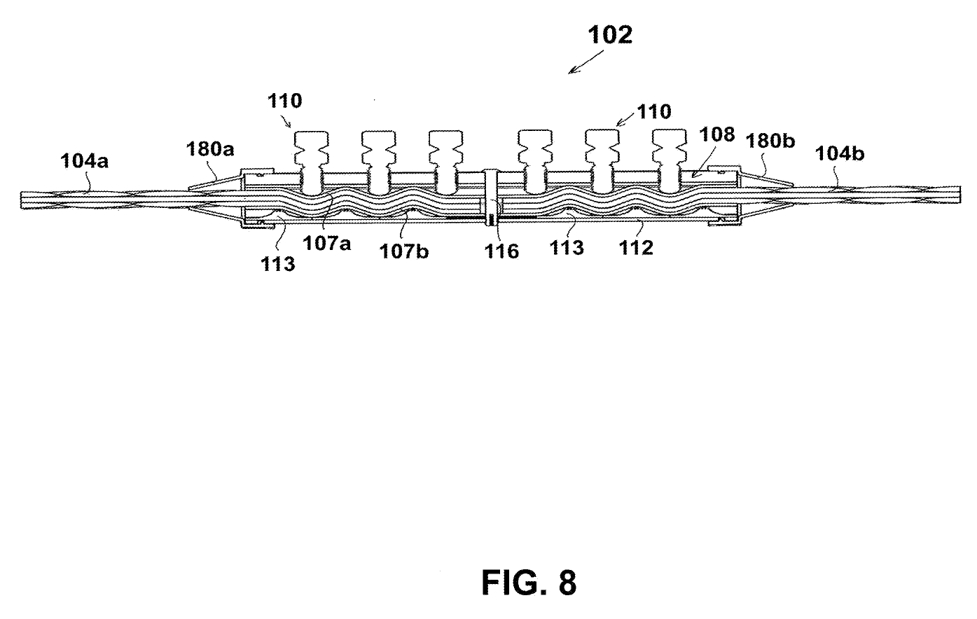

The clamp 108 includes an outer tube 112 in which the protector 106 is located. The clamp further includes a plurality of inner protrusions 113 force-fitted by sliding into a slot in the bottom of the tube 112. The protrusions 113 are formed from aluminum or brass, and located on a lower side of the coupler 102. Fasteners 110 in the form of shear bolts are located on the upper side of the coupler 102. As can best be seen in FIG. 8, the protrusions 113 and fasteners 110 are alternatingly disposed so that, in use, the protector 106 and cables 104 are corrugated and resist extraction from the clamp 108.

Turning to FIG. 7, each aluminum fastener 110 includes a head 150 from which a threaded shaft 152 extends. The head 150 defines a recess 154 such that a hexagonal tip 156 of the head 150 can be separated from the fastener 110 by shearing with a spanner. The tip 156 includes a base shelf 158 for impeding spanner (wrench, shifter or other tool) slippage to the hexagonal base 160 of the head 150 when separating the tip 156.

In use, the spanner is used to preliminarily tighten each fastener 110 until each tip 156 separates so that the cables 104 are held under preliminary pressure in an undulating or corrugated manner. Thereafter, the spanner is used to further tighten each base 160 (and place the cables 104 under greater pressure) until each base 160 separates from its threaded shaft 152 so that no part of the fastener 110 remains protruding from the clamp 108. This two-step tightening approach impedes excessive stresses on the cables 104.

The power line coupler further includes a plastic pin locator 116 extending through the center of the tube 112 and protector 106, and against which the cables 104 inserted from opposite sides of the coupler 102 can be located. The locator 116 clips or snap-fits into the tube 112 and has a split tail with projections to impede removal.

The clamp 108 also includes a pair of plastic endcaps 180a, 180b for capping the tube 112. Each cap 180 defines an internal rib or tongue for snap engaging within an endless outer groove defined in the tube 112.

A person skilled in the art will appreciate that many embodiments and variations can be made without departing from the ambit of the present invention.

The coupler 2 above included a single protector 6 and a single clamp 8. Alternatively, the coupler may instead include a protector means including two or more protectors. In yet another scenario, the coupler may instead include a clamp means including two or more clamps.

The skilled person will appreciate that the dimensions of the protector 6 and clamp 8 can be varied to suit the dimensions of the cables 4. Furthermore, the number of fasteners 10 for the clamp 8 can be varied and increase with increasing cable diameter.

In compliance with the statute, the invention has been described in language more or less specific to structural or methodical features. It is to be understood that the invention is not limited to specific features shown or described since the means herein described comprises preferred forms of putting the invention into effect. The invention is, therefore, claimed in any of its forms or modifications within the proper scope of the appended claims appropriately interpreted by those skilled in the art.

The claims defining the invention are as follows:

1. A power line coupler for coupling a pair of cables together, the coupler including:
a protector for receiving and protecting the cables, the protector including a pair of protection members between which the cables can be received; and
a clamp for clamping the protector and cables together.

2. A power line coupler as claimed in claim 1, wherein the protection members are coated with a friction enhancing compound to impede extraction of the cables.

3. A power line coupler as claimed in claim 1, wherein the protection members are formed from deformable aluminum.

4. A power line coupler as claimed in claim 1 wherein the clamp includes a plurality of inner protrusions.

5. A power line coupler as claimed in claim 4, the protrusions are located on one side of the coupler and fasteners are located on the other side of the coupler.

6. A power line coupler as claimed in claim 5, wherein the protrusions and fasteners are alternatingly disposed so that, in use, the protector is corrugated and resists extraction from the clamp.

7. A power line coupler as claimed in claim 5, wherein each fastener includes a head from which a threaded shaft extends, the head defining a recess such that a tip of the head can be separated from the fastener by shearing.

8. A power line coupler as claimed in claim 7, wherein the tip includes a base shelf for impeding tool slippage when separating the tip.

9. A power line coupler as claimed in claim 1, further including a locator extending through the protector and against which the cables inserted from opposite sides of the coupler can be located.

10. A power line coupler as claimed in claim 1, wherein the clamp includes a tube.

11. A power line coupler as claimed in claim 10, wherein the clamp includes one or more endcaps for capping the tube.

12. A power line coupler for coupling a pair of cables together, the coupler including:
an inner pair of protection members for receiving the cables; and
a tube for receiving the protection members.

13. A power line coupler as claimed in claim 10, wherein inner protrusions are located on one side of the coupler and fasteners are located on the other side of the coupler.

14. A power line coupler as claimed in claim 13, wherein the protrusions and fasteners are alternatingly disposed so that, in use, the protector is corrugated and resists extraction from the coupler.

15. A power line coupler as claimed in claim 12, further including fasteners for extending through the tube, each fastener including a head from which a threaded shaft extends, the head defining a recess such that a tip of the head can be separated from the fastener by shearing.

16. A power line coupler as claimed in claim 10, further including a locator extending through the coupler against which the cables inserted from opposite sides of the coupler can be located.

17. A power line coupler for coupling a pair of cables together, the coupler including:
protector means for receiving and protecting the cables;
clamp means for clamping the protector means and cables together; and
a plurality of inner protrusions located within the clamp means to bear against the protector means.

18. A power line coupler as claimed in claim 17, wherein the protector means includes a pair of protection members between which the cables can be received.

19. A power line coupling method for coupling a pair of cables together, the method including the steps of:
receiving the cables within a protector; and
clamping the protector and cables together using fasteners on one side of the protector only.

20. A power line coupling method as claimed in claim 19, wherein the step of clamping involves separating a tip of the fasteners by shearing.
